(19) United States
(12) Patent Application Publication
(10) Pub. No.: US 2026/0019028 A1
(43) Pub. Date: Jan. 15, 2026

(54) ROTATION LOCKING ASSEMBLIES FOR REDUCING TORSIONAL GALLOPING IN SOLAR TRACKING SYSTEMS

(71) Applicant: ARRAY TECH, INC., Albuquerque, NM (US)

(72) Inventors: Thierry Marin-Martinod, Chandler, AZ (US); Nathan Schuknecht, Golden, CO (US); Kevin Krautbauer, Phoenix, AZ (US)

(21) Appl. No.: 19/261,292

(22) Filed: Jul. 7, 2025

Related U.S. Application Data
(60) Provisional application No. 63/669,915, filed on Jul. 11, 2024.

(51) Int. Cl. H02S 20/32

(52) U.S. Cl. CPC H02S 20/32

(57) ABSTRACT

Embodiments of the present disclosure include a rotation locking assembly for addressing dynamic effects of photovoltaic (PV) modules in a solar installation. In some embodiments, the rotation locking assembly includes a rotational locking mechanism, where the rotational locking mechanism includes a shaft, a locking component rotationally connected to the shaft, and a static cog that may be configured to engage the locking component and stop rotation of the shaft. Additionally, the rotation locking assembly includes a means for transmitting rotation of a torque tube to rotation of the shaft, where the locking mechanism is configured to limit rotation of the torque tube in response to an angular velocity of the torque tube exceeding a threshold.

### CROSS-REFERENCE TO RELATED APPLICATION

This application claims the benefit of U.S. Patent Application Ser. No. 63/669,915, filed on Jul. 11, 2024, which is incorporated herein by reference in its entirety.

### TECHNICAL FIELD

The present disclosure relates to rotation locking assemblies designed to address dynamic effects in solar tracking systems, the dynamic effects including phenomena such as, for example, torsional galloping, fluttering, torsional divergence, among others.

### BACKGROUND

Solar farms, photovoltaic (PV) plants, and other solar energy systems where large numbers of PV modules collect sunlight and generate energy are becoming more common. In some of these systems, multiple PV modules may be coupled to a torque tube, which is mounted on one or more support structures or piles. Mounting interfaces may be used to secure a PV module mounting structure to the torque tube. In solar tracking systems (or systems in which the PV modules are able to track a location of the sun throughout the day), the torque tube is designed to permit rotation of the PV modules relative to the support structure. In some instances, rotation of the torque tube may be facilitated and/or controlled by a tracker drive assembly that may be placed, for example, in the middle of a torque tube to control the rotation of PV modules attached thereto. Selective rotation of the PV modules may enable more efficient ways of collecting power from the Sun; however, rotation is not always selected. Rather, rotation may also be caused by a number of other external factors and forces such as, for example, wind, snow accumulation, etc., where those external forces may be acting on the PV modules, torque tubes, or support structures.

In some instances, to combat the external forces acting to turn the PV modules, many tracker drive assemblies may be configured to lock, stop, or limit rotation of the torque tube and PV modules. In many instances, however, the torque tube and rows of solar modules may be tens or hundreds of meters long. Resultingly, wind applying a torsional force on one end of the torque tube, for example, may result in significant rotational movement relative to the tracker drive assembly located elsewhere on the torque tube.

In addition, forces applied on a particular portion of the torque tube may result in rotation or torsional forces that may propagate throughout the torque tube. In some instances, external forces interact with the torque tube and PV modules in a way that creates self-excited oscillations which may interact with the natural frequency of the PV modules and torque tube creating a feedback loop. In some instances, the feedback loop may exacerbate the self-excited oscillations generating a phenomenon known commonly as “torsional galloping.” Torsional galloping may lead to damaged PV modules, torque tubes, tracker drive assemblies, etc.

Existing solar power installations combat torsional galloping and other related phenomena using, for example, fluid shock absorbers placed in one or more locations along the torque tube. However, these solutions are typically expensive to implement and difficult to install. In addition, the fluid shock absorbers may not be sufficient to lock torque tubes in place in instances where the torque applied, the angular velocity, and/or the angular acceleration of the torque tube exceeds a particular threshold. Accordingly, there is a need for an improved torque limiter that reduces rotational torque on tracker drive assemblies, is inexpensive, easy to install, and that may effectively lock the torque tube in place depending on an amount of torque or angular velocity and/or angular acceleration of the torque tube, PV modules, and corresponding support structures

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in conventional solar tracking systems, including problems associated with damage to tracker drive assemblies, torque tubes, solar modules, and other supporting structures caused by angular velocity, angular acceleration, excess torsion and/or torsional galloping generated from wind, seismic activity, or other external forces.

Embodiments disclosed herein address this problem by providing a rotational locking mechanism that may be configured to limit rotation or lock rotation of the torque tube. Embodiments of the present rotational locking mechanism are inexpensive to manufacture, operate, and install. In addition, rotational locking mechanisms of the present disclosure may be placed or installed in various locations along the length of a torque tube thereby providing several locations to limit rotation of the torque tube. Additionally, by limiting torque, angular velocity, and/or angular acceleration at various points along the torque tube, the rotational locking mechanism may limit or eliminate the effects of torsional galloping on the solar installation, which may reduce damage to the components of the tracker drive assembly, the PV module, the torque tube, and other supporting structures.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the accompanying drawings in which:

FIG. 1 illustrates an exemplary solar power system where a rotational locking mechanism is installed;

FIGS. 2A-2H illustrate a variety of views and components of exemplary configurations of rotational locking mechanisms;

FIGS. 3A-3C illustrate an example system including two rotational locking mechanisms designed to limit the angular velocity/acceleration of the torque tube;

FIGS. 4A-4B illustrate an example system including two rotational locking mechanisms using a single cable to limit the angular velocity/acceleration of the torque tube;

FIGS. 5A-5B illustrate an example system including rotational locking mechanisms where corresponding belts attach directly to the torque tube; and

FIG. 6 illustrates an example system including a single rotational locking mechanism using two gears to translate rotational movement of the torque tube to the single rotational locking mechanism;

all in accordance with one or more embodiments of the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

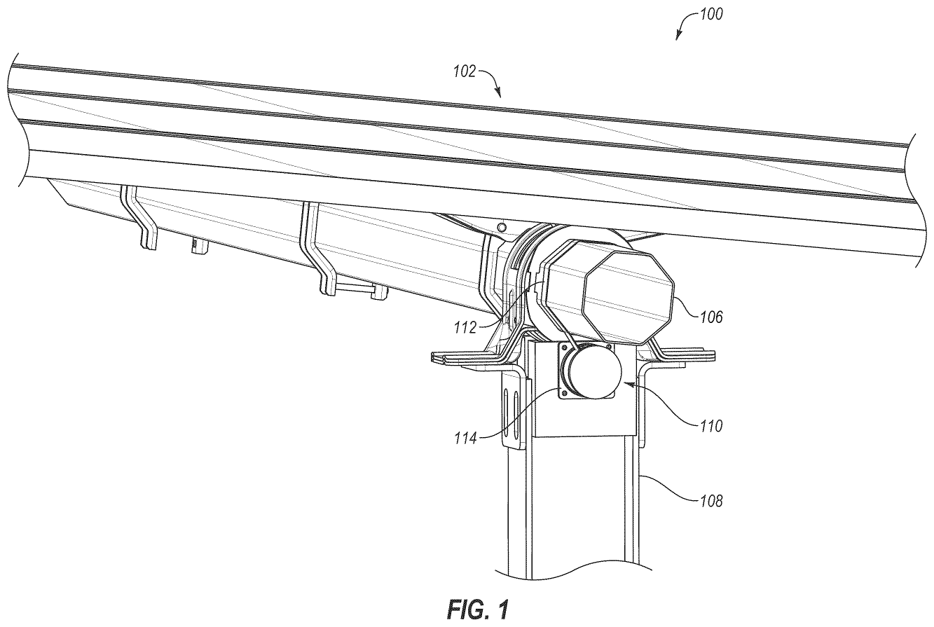

FIG. 1 illustrates an exemplary solar power system 100 where a rotational locking mechanism 110 is installed. The system 100 includes a PV module 102 that is connected to torque tube 106. As referred to herein, the PV module 102 may include one or more solar modules that may be electrically connected or otherwise wired together. The PV module 102 may additionally include glass paneling and metal framing that may surround the outer surfaces of the PV module 102 such that the PV module 102 may be mounted, for example, on torque tube 106. As shown in FIG. 1, the PV module 102 is mounted or attached to the torque tube 106 using one or more attaching mechanisms including, for example, mounting rails, mounting brackets, etc. In some embodiments, the PV module 102 may be rotationally attached to the torque tube 106 such that the PV module 102 will rotate in response to rotation from the torque tube 106—e.g., using one or more solar tracking systems.

The torque tube 106 may be mounted atop one or more support beams 108. In some embodiments, the support beam 108 may provide support and lift the torque tube 106 and the PV module 102 off of the ground. In some embodiments, the torque tube 106 may be mounted on several support beams 108 that may be spaced at regular intervals along the length of the torque tube 106 acting as anchor points, remaining static and providing support for the weight of the PV modules 102, torque tubes 106, and corresponding assemblies. In some embodiments and, as shown in FIG. 1, the mounting structure 114 corresponding to the rotational locking mechanism 110 may be mounted onto the support beam 108.

As shown in FIG. 1, the mounting structure 114 is attached to the support beam 108 such that the mounting structure 114 remains static in relation to the support beam 108. In some embodiments, the mounting structure 114 may be attached to the support beam 108 using one or more attaching mechanisms, such as, for example, one or more screws, anchors, pins, etc. As shown in FIG. 1, the mounting structure 114 includes four holes, one in each corner, where each of the holes may be configured to receive screws, anchors, pins, etc. The mounting structure 114 is designed to attach to one or more other elements, structures, or mechanisms corresponding to the rotational locking mechanism 110 such that the rotational locking mechanism 110, as a whole, may remain static relative to the support beam and/or the torque tube 106.

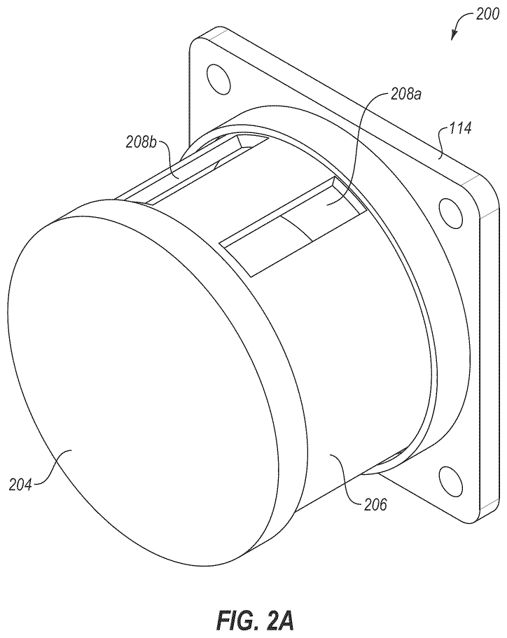

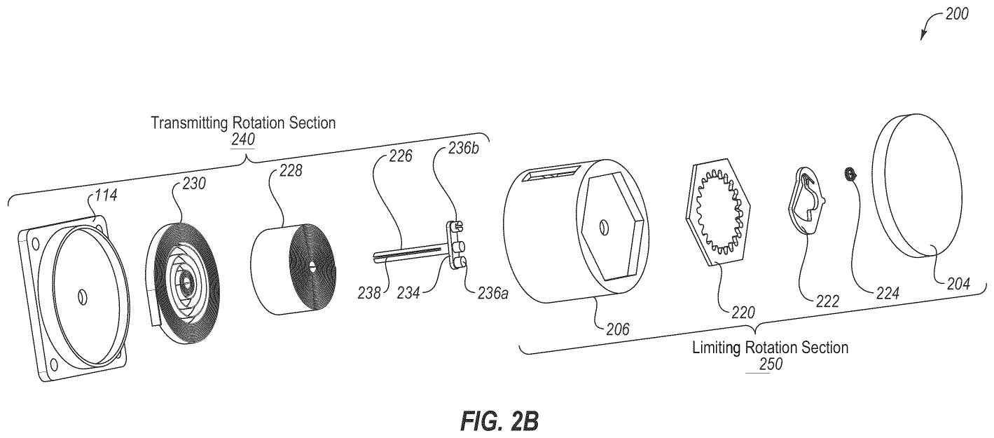

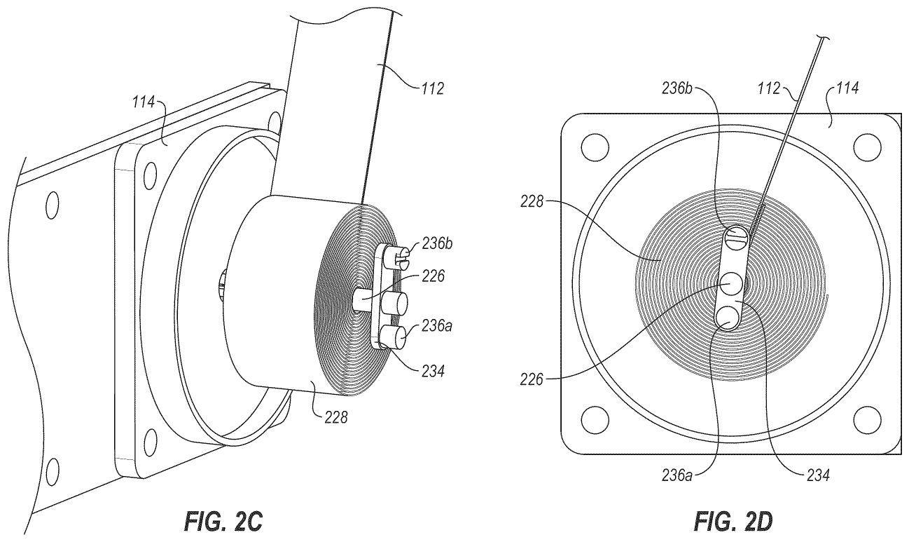

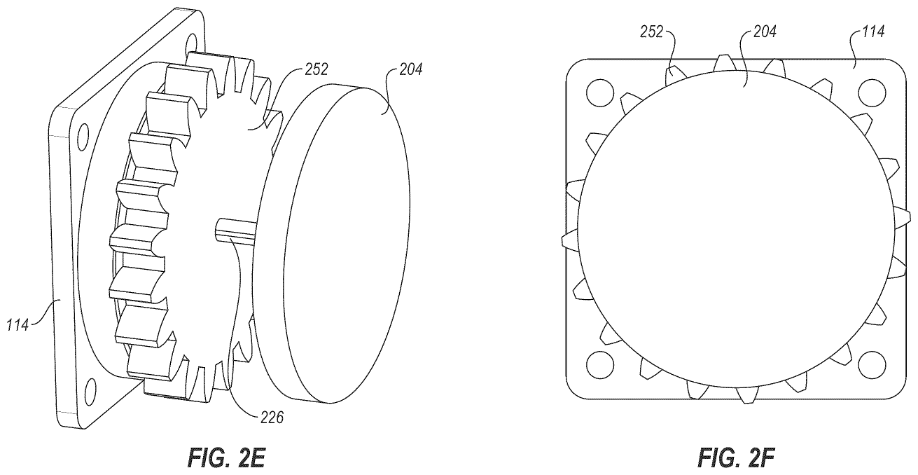

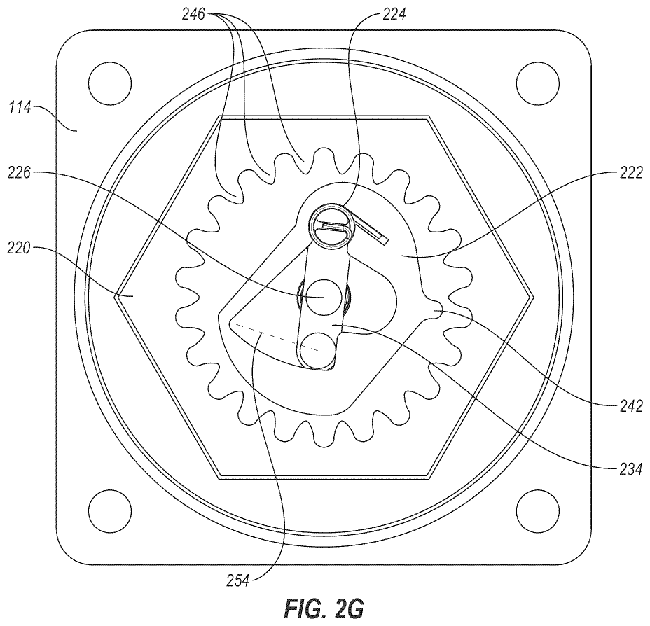

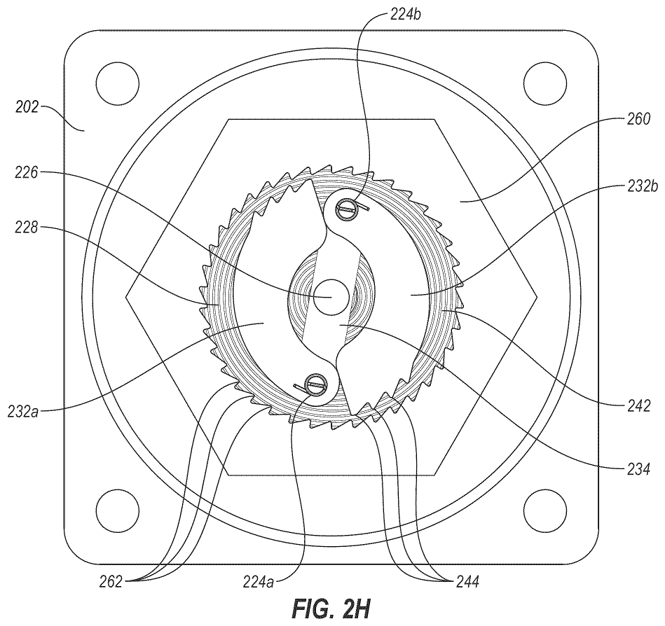

The rotational locking mechanism 110, as shown in FIG. 1, illustrates an outer housing assembly corresponding to the rotational locking mechanism 110. In some embodiments, the rotational locking mechanism 110 may include one or more moving parts, mechanisms, etc. that are within the outer housing assembly; the moving parts, mechanisms, etc. may be described and/or illustrated further in the present disclosure, such as, for example, in FIGS. 2A-2H.

The rotational locking mechanism 110 may be designed to limit rotation of the torque tube 106 in response to an angular velocity or acceleration of the torque tube 106 exceeding a particular threshold. In some embodiments, the threshold may include any angular velocity or rotational acceleration that exceeds a maximum angular velocity and/or angular acceleration achieved using a tracker drive assembly designed to rotate the torque tube 106 and PV modules 102. For example, the threshold may include an angular velocity or angular acceleration that exceeds the rotation of the torque tube 106 in response to movement of the Sun, rotation of the torque tube 106 in response to a weather event, or an angular velocity or acceleration that exceeds a determined threshold (e.g., 10 degrees per minute, 20 degrees per minute, etc.). In some instances, the threshold may be determined based on one or more other metrics such as, for example, whether the angular velocity or acceleration exceeds a limit that may cause damage to the torque tube 106, the PV module 102, or other support structures corresponding thereto. In some instances, the threshold may include any rotation during time periods where the tracker drive assembly is not initiating rotation of the torque tube.

To limit rotation of the torque tube 106, the rotational locking mechanism 110 may employ one or more methods or mechanisms to transmit rotation of the torque tube 106 to the rotational locking mechanism 110, many of which are described in further detail, for example, in FIGS. 2A-6. The rotational locking mechanism 110 is engaged based on components of the rotational locking mechanism 110 moving progressively outward based on the components' angular velocities. The outward movement may be described as inertia resisting the inward centripetal force acting on components of the rotational locking mechanism 110 using the rotation transmitted from the torque tube 106. In some instances, the tendency for portions of the rotational locking mechanism 110 (e.g., locking components 222 and/or locking components 232) may be described by a perceived “centrifugal force” acting on, for example, locking components 222 and 232.

As shown in FIG. 1, the rotational locking mechanism 110 employs a belt 112 that wraps around the torque tube 106. In some embodiments, the belt 112 may be coupled to the torque tube 106 at a single location. In some embodiments, the belt 112 may be coupled to the torque tube 106 at multiple locations. The belt 112 is also coupled or attached to the rotational locking mechanism 110. The angular velocity or acceleration with which the torque tube 106 rotates causes the belt 112 to extend out of or retract into the rotational locking mechanism 110 thereby transmitting the rotation and relative speed and acceleration of the torque tube 106 to the rotational locking mechanism 110. The belt 112 is one example of a means for transmitting rotation from the torque tube 106 to the rotational locking mechanism 110. In some embodiments, the belt 112 may be constructed of a number of materials (e.g., metal, composites, plastic, leather, etc.) The belt 112 need not have a particular cross-sectional shape; for example, the belt 112 may be wide and flat with a rectangular cross-sectional shape in some instances and, in others, the belt 112 may include one or more wires with a circular cross-sectional shape that may be configured to wrap around the torque tube 106 and attach to the rotational locking mechanism 110. The belt 112 may also include a chain with individual links that transfer rotation from the torque tube 106 to the rotational locking mechanism 110.

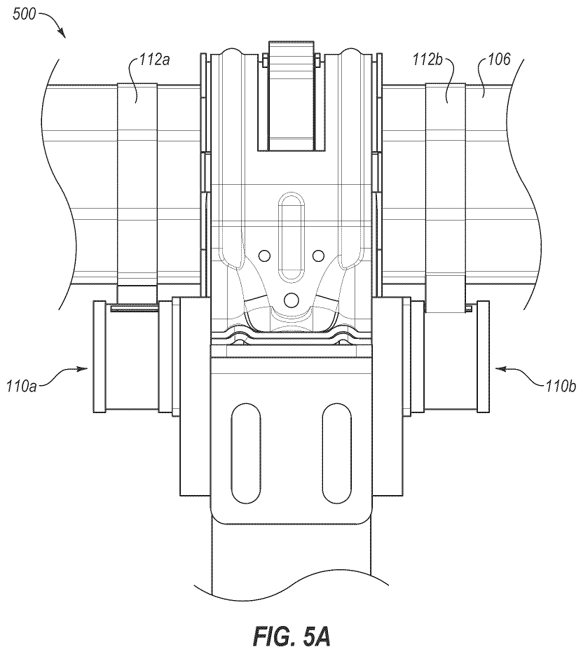

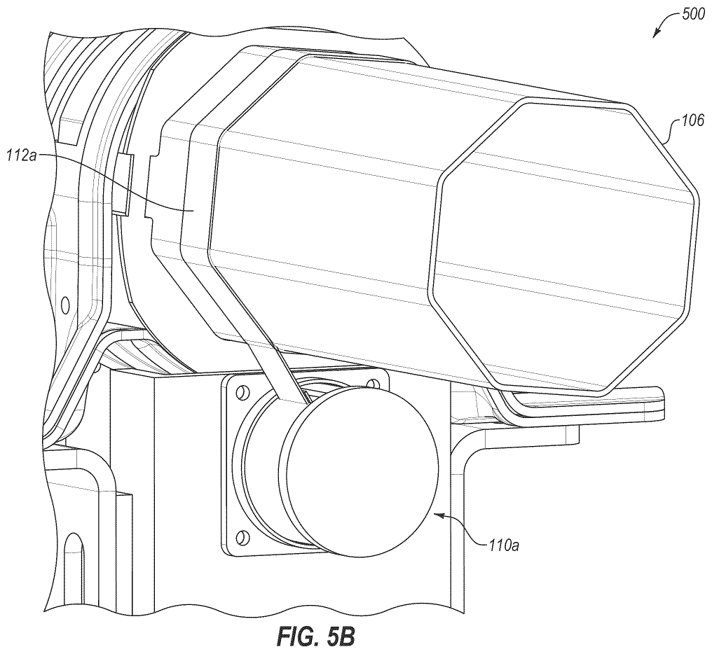

In some embodiments, the system 100 may include multiple locking mechanisms 110. As shown in FIG. 1, the belt 112 that is rotationally attached to the torque tube 106 may transmit rotation of the torque tube 106 in a manner that will engage the rotational locking mechanism 110 in one rotational direction—e.g., clockwise or counterclockwise. In some embodiments, the system 100 may include an additional rotational locking mechanism 110 attached to the support beam 108 opposite the side shown in FIG. 1. The second rotational locking mechanism 110 may be attached to a second belt 112 that may wrap around the torque tube in a direction opposite to the belt 112 shown in FIG. 1. In some embodiments, having belts 112 wrapped around the torque tube 106 opposite one another may enable the rotational locking mechanisms 110 to limit or lock rotation of the torque tube 106 in both rotational directions. In some embodiments, the configuration of the system 100 with two rotational locking mechanisms 110, one mounted on either side of the support beam 108, may be described and/or illustrated further in the present disclosure, such as, for example, with respect to FIGS. 5A-5B.

Modifications, additions, or omissions may be made to the solar power system 100 without departing from the scope of the disclosure. For example, the location where the mounting structure 114 may be attached to the support beam 108 may vary. In addition, the size, shape, and orientation of the torque tube 106 and the rotational locking mechanism 110 may vary. The materials, structures, and design of the belt 112 may also vary in addition to the ways in which the rotation of the torque tube 106 may be transmitted to the rotational locking mechanism 110. The designations of different elements in the manner described is meant to help explain concepts described herein and is not limiting. Further, the solar power system 100 may include any number of other elements or may be implemented within other systems or contexts than those described.

FIGS. 2A-2H illustrate a variety of views and components of exemplary configurations of rotational locking mechanisms 110 which are analogous to or the same as the locking mechanism 110 illustrated in FIG. 1. Specifically, FIG. 2A illustrates an example external view of the rotational locking mechanism 110. FIG. 2B illustrates an exploded view of the parts included in an example configuration of the rotational locking mechanism 110. FIGS. 2C-2D illustrate an example view of a coil 228 and belt 112 configuration for transmitting rotation from a torque tube 106 to a shaft 226. FIGS. 2E-2F illustrate an example view of a gear 252 transmitting rotation from the torque tube 106 to the shaft 226. The gear 252 is another example of a means for transmitting rotation from the torque tube 106 to the rotational locking mechanism 110. FIG. 2G illustrates and example assembly for locking or limiting rotation of the shaft using a single locking component 222. FIG. 2H illustrates and example assembly for locking or limiting rotation of the shaft using multiple locking components 232.

As shown, for example, in FIG. 2A, the locking mechanism 110 may include one or more external portions that may house internal assemblies or mechanisms configured to limit the rotation of the torque tube 106. In some embodiments, the external portions of the rotational locking mechanism 110 may be integrally formed or formed, molded, machined, etc. from one piece of material. In some embodiments, and as shown in FIG. 2A, the external portions of the rotational locking mechanism 110 may be formed out of multiple parts that are fit together. In some embodiments, though not explicitly shown in FIG. 2A, the external portions of the rotational locking mechanism 110 may include one or more seals, skirts, sealed connectors, coatings, etc. that may enable the locking mechanism 110 to be resistant to harsh environmental conditions associated with solar installations (e.g., moisture, wind, UV exposure, extreme temperatures, etc.)

In some embodiments, the rotational locking mechanism 110 may include the mounting structure 114 which may be configured to mount or attach the rotational locking mechanism 110 to one or more portions of a solar installation, e.g., one or more portions of the solar power system 100 as described further, for example, in FIG. 1. For example, the mounting structure 114 may attach to the support beam 108 where the mounting structure 114 may serve as an anchor-like-structure enabling the rotational locking mechanism 110 to remain static relative to the torque tube 106 and/or the PV module 102.

In some embodiments, the rotational locking mechanism 110 additionally includes a housing 206 that may surround one or more internal parts, portions, or pieces, of the rotational locking mechanism 110, the internal parts shown, for example, in FIG. 2B. In some embodiments, and as shown in FIG. 1, the housing 206 defines two apertures 208—a first aperture 208a and a second aperture 208b. The first and second apertures 208a and 208b are individually configured to receive a belt, such as, for example, the belt 112 described with respect to FIG. 1. The first and second apertures 208a and 208b may be large enough to allow movement of the belt 112 in and/or out of the first and second apertures 208a and 208b. The size, shape, and orientation of the first and second apertures 208a and 208b may be defined based on the size, shape, and orientation of the belt 112.

Further, as shown in FIG. 1, the rotational locking mechanism 110 includes an end cap 204, where the end cap 204 is attached to the housing 206 to cover and/or protect one or more internal parts, portions, pieces, of the rotational locking mechanism 110. In some embodiments, the end cap 204 may additionally house one or more internal pieces or parts of the rotational locking mechanism 110 as shown in further detail, for example, in FIGS. 2B-2H. In some embodiments, the mounting structure 114, the housing 206, and the end cap 204 may house and protect the internal parts and mechanisms included in the rotational locking mechanism 110 from one or more environmental conditions (e.g., moisture, wind, UV exposure, extreme temperatures, etc.) In some embodiments, the mounting structure 114, the housing 206, and the end cap 204 may all be fitted together to allow internal portions of the rotational locking mechanism 110 to limit rotation of a torque tube (e.g., the torque tube 106.)

Example internal parts or pieces of the rotational locking mechanism 110 are described and/or illustrated with respect to FIG. 2B, which illustrates an exploded view of an example configuration of a rotational locking mechanism 110. While the rotational locking mechanism 110 is not necessarily delineated into two different parts or sections, for the sake of describing its function, two sections are identified: (1) a transmitting rotation section 240, and (2) a limiting rotation section 250.

The transmitting rotation section 240 is configured to transmit rotation of a torque tube (e.g., the torque tube 106) and/or a PV module (e.g., the PV module 102) to the rotational locking mechanism 110. In some embodiments, the components and mechanisms corresponding to the transmitting rotation section 240 may be described generally as a means for transmitting rotation from the torque tube 106 to a shaft 226. The limiting rotation section 250 is configured to stop or limit rotation of the torque tube (e.g., the torque tube 106) or the PV module (e.g., the PV module 102) using motion or rotation transmitted from the torque tube 106 to the limiting rotation section 250. In some embodiments, the components and mechanisms corresponding to the limiting rotation section 250 may be described generally as a means for limiting or locking rotation of the torque tube 106.

As shown in FIG. 2B, the transmitting rotation section 240 includes individual parts included in the rotational locking mechanism 110 between the mounting structure 114 and the housing 206. The transmitting rotation section 240, in FIG. 2B, includes a shaft 226 that may be rotationally attached to the mounting section 114 and/or the housing 206. The shaft 226 includes a proximal end and a distal end, the proximal end, as shown in FIGS. 2B and 2C, is rotationally attached to torsional spring 230 and/or the mounting structure 114. The distal end of the shaft 226 may be attached to a rotating member 234.

In some embodiments, and as shown in FIG. 2B, the proximal end of the shaft 226 may define a slot 238 where a portion of the belt 112 and/or the coil 228 may be received. For example, the belt 112 may be inserted or threaded into the slot 238 of the shaft 226. The belt 112 may then be wrapped around the shaft 226 to form the coil 228. In some embodiments, by threading or inserting the belt 112 into the slot 238, extending or retracting the belt 112 may result in rotating the shaft 226. In some embodiments, while the coil 228 is shown having a particular cross section (e.g., a rectangular cross section), the coil 228 may be made up of materials with differing cross sections as long as materials used may be wrapped around the shaft 226 to form the coil 228.

In some instances, the proximal end of the shaft 226 may additionally be configured to attach to the torsional spring 230. In some instances, one end of the torsional spring 230 is inserted or threaded through the slot 238 defined by the proximal end of the shaft 226. The other end of the torsional spring 230 may be attached to the mounting structure 114. The torsional spring 230 may be constructed out of a number of different materials—e.g., metals, composites, high-performance plastics, etc. As shown in FIG. 2B, the torsional spring 230 includes material with a rectangular cross-section, and the torsional spring 230 may be constructed in some instances out of materials with different cross sections such as, for example, wires having different diameters.

In some embodiments, the torsional spring 230 may be configured to apply a torque or a rotational force proportional to an experienced angle of rotation of the shaft 226. In some instances, rotating the shaft 226 in a particular direction may rotate or elastically deform the torsional spring 230 which causes the torsional spring 230 to store potential energy and apply a restoring torque on the shaft 226 that is proportional to an angle of rotation associated with the shaft 226. In some embodiments, the restoring torque may be applied to the shaft 226 regardless of the direction the shaft 226 is rotated. In some embodiments, the torsional spring 230 may be constructed or chosen based on an amount of restoring torsional force that may be applied to the shaft 226. In some embodiments, the torsional spring 230 may enable the belt 112 to retract or extend back to a state of equilibrium. For example, in instances where the belt 112 is pulled out of the housing 206, the torsional spring 230 may apply a restoring torque or rotational force to the shaft 226 until the belt 112 retracts and wraps back into the coil 228.

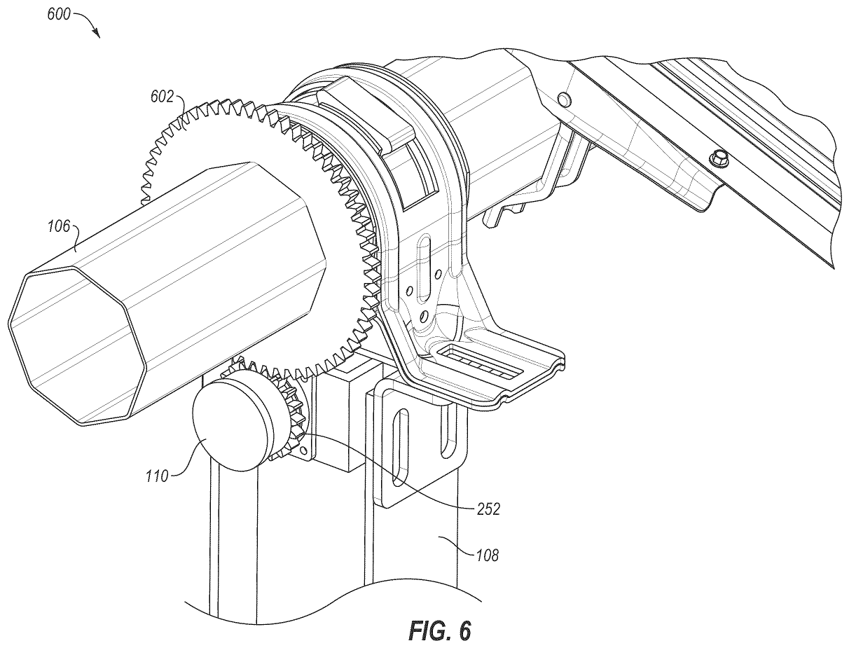

In some embodiments, the transmitting rotation section 240 may include one or more different parts or mechanisms configured to transmit rotation of the torque tube 106 to the shaft 226. For example, as shown in FIGS. 2E and 2F, the transmitting rotation section 240 may include multiple gears that may be configured to interface to transmit rotation of the torque tube 106 to the shaft 226. For example, a first gear 252 may be rotationally attached to the shaft 226 such that rotating the first gear 252 may rotate the shaft 226. The first gear 252 may include multiple pinions or gear teeth that may be configured to interface with pinions or gear teeth corresponding to a second gear such as, for example, second gear 602 illustrated, for example, with respect to FIG. 6. In some embodiments, the second gear 602 is rotationally attached to the torque tube 106 such that rotation of the torque tube 106 may translate into rotation of the second gear 602. In some embodiments, the rotation of the torque tube 106 and, consequently, the second gear 602 may cause rotation of the first gear 252 and the shaft 226. In some embodiments, by using the first gear 252 and the second gear 602 to transmit rotation of the torque tube 106, rotation of the torque tube 106 may be transmitted in either rotational direction, much like the extending and retracting of the belt 112. The use of the first gear 252 and the second gear 602 may be an example of a means for transmitting rotation from the torque tube 106 to the rotational locking mechanism 110.

Returning to FIG. 2B, the rotating member 234 is attached to the distal end of the shaft 226 and may be shaped to transmit rotation of the shaft 226 to locking component 222. The rotating member 234 in FIG. 2B is attached perpendicularly relative to the shaft 226 and includes two protrusions 236—a first protrusion 236a and a second protrusion 236b. The second protrusion 236b may be configured to receive spring 224 and attach to the locking component 222. The first protrusion 236a may be configured to limit rotation of the locking component 222 to a particular path or location. For example, the spring 224 may be attached to the second protrusion 236b and may be configured to allow rotation of the locking component 222 at different rates than the shaft 226. For example, the shaft 226 may rotate quickly which may result in rotation of the rotating member 234 and, as a result rotation of the locking component 222. In response to being attached to the spring 224, the locking component 222 may rotate at a different rate thus applying a torsional force or a rotational force to the spring 224. By rotating at a different rate, the locking component 222 may rotate along a different circumferential path, where the different circumferential path is limited to a certain circumference based on the first protrusion 236a interfacing with a portion of the locking component 222. The locking component 222 may move along a path relative to the first protrusion 236a denoted as dotted line 254 as shown, for example, in FIG. 2G.

In some embodiments, by rotating at a different rate and along a different circumferential path, the locking member 222 may be configured to engage one or more internally facing pinions 246 corresponding to an internal gear 220. For example, FIG. 2G illustrates a pin or protruding member 242 corresponding to the locking component 222 that may be configured to engage one or more of the pinions 246. In response to the internal gear 220 being static and the locking component 222 being dynamic or configured to rotate and/or translate, the pin or protruding member 242 engaging the internal gear 220 may stop or limit rotation of the locking component 222 and, correspondingly, the shaft 226, the belt 112, and the torque tube 106 may stop or be otherwise limited. As shown in FIG. 2G, the locking member 222 may be configured to stop or limit rotation of the shaft 226 based on angular velocity corresponding to rotation of the shaft 226 and, correspondingly, the locking component 222 in either rotational direction—e.g., clockwise or counterclockwise. For the configuration shown in FIG. 2G, the locking member 222 is configured to stop or limit the rotation of the shaft 226 based on the shaft 226 rotating in a clockwise direction. In some embodiments, the locking member 222 may be configured to stop or limit rotation of the shaft 226 in either a clockwise or counterclockwise direction.

In some embodiments, while the locking member 222 and internal gear 220 may be shown as an example of a mechanism designed to lock or limit rotation of the shaft 226 and, correspondingly, the torque tube 106, the internal gear 220 and locking member 222 are not required to lock or limit rotation of the shaft 226. While illustrated in the present disclosure as an internal gear 220 with multiple pinions or gear teeth engaging with a locking component to stop rotation of the shaft 226, in some instances, a single static cog may be enough to interact or engage with a pin or locking component to stop rotation of the shaft 226, where the pin corresponds to the rotation of the shaft 226. In some embodiments, the pin engaging with the single, static cog, may be enough to limit the rotation of the shaft 226 and the torque tube 106.

In some instances, the limiting rotation section 250 may include one or more other parts and mechanisms that may be configured to stop or limit rotation of shaft 226, the belt 112, the first gear 252 and, correspondingly, the torque tube 106. For example, as shown in FIG. 2H, the locking component 222 may instead include two locking components 232 (a first locking component 232a and a second locking component 232b) each including a first end and a second end. The first ends of the first and second locking components 232a and 232b may be connected to the first and second protrusions 236a and 236b respectively. In some embodiments, and as shown in FIG. 2H, the first ends of the locking components 232 may additionally be connected to the protrusions 236 and springs 224—e.g., a first spring 224a and a second spring 224b.

In some embodiments, the rotation of the shaft 226 may rotate the rotation member 234 and, correspondingly, the locking components 232. In some instances, in response to the rotation member 234 and the locking components 232 rotating at an angular velocity and/or acceleration that exceeds a threshold, the locking components 232 may splay outward, both rotating along expanding circumferential paths. In some instances, the expanding circumferential paths may enable the locking components 232 and/or the one or more engaging features 244 to engage with the pinions 262 of the internal gear 260. In some embodiments, the one or more engaging features 244 may be shaped, sized, and/or oriented to engage with the one or more pinions 262 such that the engaging features 244 engage the pinions 262 to stop rotation only in one rotational direction. Much like the locking component 222 the locking components 232 engaging with the pinions 262 may stop or limit the rotation of the shaft 226, movement of the belt 112 and/or the first gear 252. In some embodiments, the threshold with which the locking components 232 may rotate along expanding circumferential paths may be adjusted based on stiffness of the springs 224.

In some embodiments, the first and second locking components 232a and 232b may stop or limit rotation of the shaft 226 in different directions. For example, as shown in FIG. 2H, the first and second locking components 232a and 232b each include engaging features 244 that may stop rotation of the shaft 226 in a clockwise direction based on the shape and orientation of the engaging features 244 and the pinions 262. In some embodiments, the shape and orientation of the engaging features 244 and the pinions 262 may be such that the first locking component 232a may be configured to stop rotation of the shaft 262 in a clockwise direction and the second locking component 232b may be configured to stop rotation of the shaft 262 in a counterclockwise direction. In some instances, the internal gear 260 and/or the pinions 262 may be the same as and/or analogous to the internal gear 220 and/or the pinions 246 associated with the internal gear 220.

Modifications, additions, or omissions may be made to the rotational locking mechanism 110 without departing from the scope of the disclosure. For example, the parts and/or mechanisms corresponding to the transmitting rotation section 240 and/or the limiting rotation section 250 may vary. The sizes and shapes that may be illustrated in various components of the rotational locking mechanisms 110 may vary. The designations of different elements in the manner described is meant to help explain concepts described herein and is not limiting.

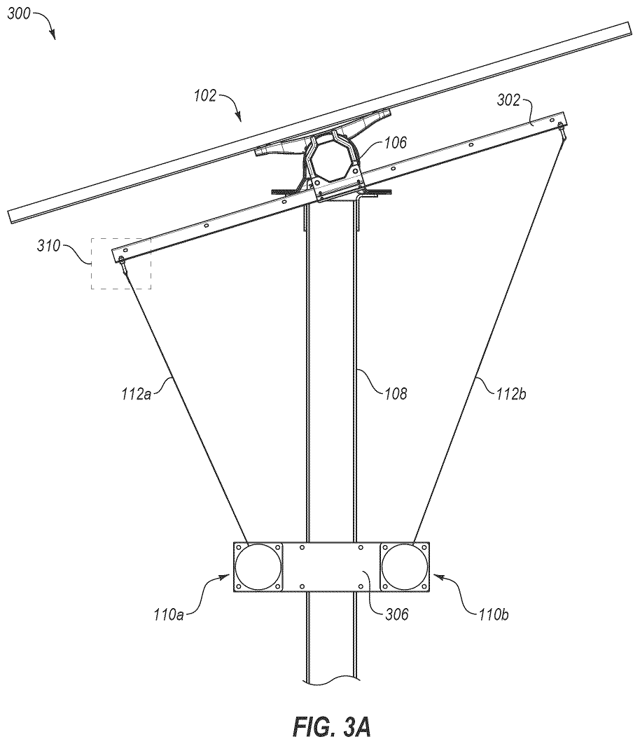

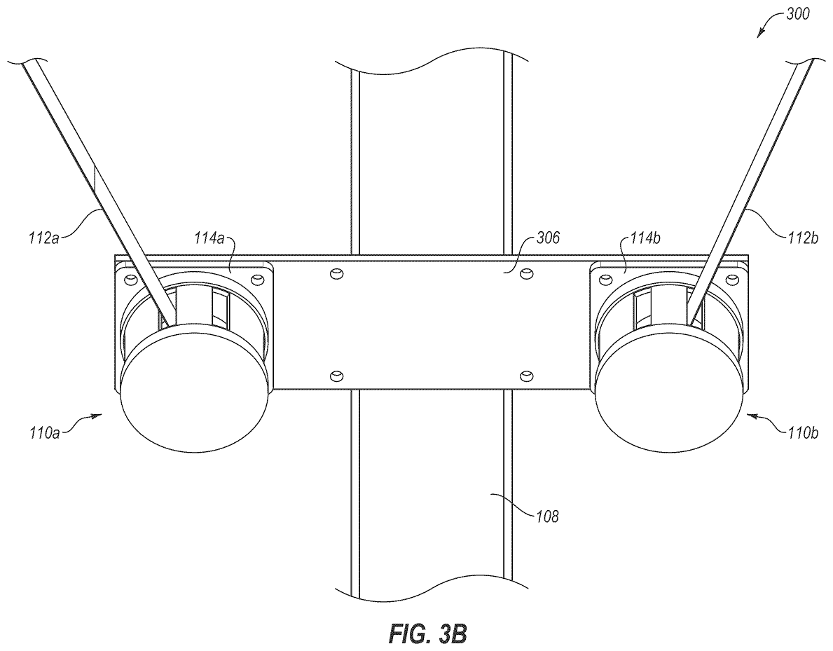

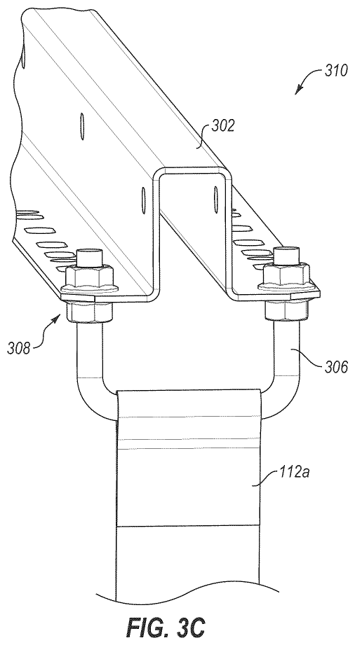

The rotational locking mechanism 110 may be implemented in a number of different manners and in a number of different solar installations. FIGS. 3A-3C illustrate various views corresponding to an example system 300 including a first rotational locking mechanism 110a and a second rotational locking mechanism 110b both of which are designed to limit the angular velocity/acceleration of the torque tube 106. As shown in FIGS. 3A and 3B, the first and second rotational locking mechanisms 110a and 110b are attached to the support beam 108 using a mounting bracket 306 such that the mounting bracket 306 remains static with respect to the support beam 108. In addition, each of the mounting structures 114 corresponding to the first and second locking mechanisms 110a and 110b are attached to the mounting bracket 306 and are similarly static with respect to the support beam 108 and the mounting bracket 306.

The first rotational locking mechanism 110a may be configured to stop or limit rotation of the torque tube 106 and/or the PV module 102 in a clockwise direction and the second rotational locking mechanism 110b may be configured to stop or limit rotation of the torque tube 106 and/or the PV module 102 in a counterclockwise direction. The first rotational locking mechanism 110a may include a first belt 112a that may be rotationally attached to a shaft (e.g., the shaft 226) within the first locking mechanism 110 and a rod 302. The second rotational locking mechanism 110b may include a second belt 112b that may be rotationally attached to a shaft (e.g., the shaft 226) within the second locking mechanism 110 and the rod 302.

The rod 302 is configured to attach to the torque tube 106 such that the rod 302 rotates in response to rotation of the torque tube 106. The first and second belts 112a and 112b may attach to either end of the rod 302 and, in response to rotation of the torque tube 106, the rod 302 may rotate and either pull out or extend one of the first or second belts 312a or 312b or allow one of the first or second belts 312a or 312b to retract into either the first or second rotational locking mechanisms 110a or 110b. In some embodiments, the belt 312 is configured to attach to the rod 302 at an example attaching section 310.

The example attaching section 310 is illustrated in FIG. 3C which illustrates an end of the first belt 112a that is attached or wrapped around a U-bolt 306. The U-bolt is attached on either end of the rod 302 using one or more nuts and washers, where the connection between the U-bolt 306 and the rod 302 may be strong enough to resist stresses and strain associated with tension forces corresponding to the first and/or second belts 312a and/or 312b.

For example, in instances where a gust of wind may cause rotation of the torque tube 106 in a counterclockwise direction the second belt 112b may be pulled out or extend from the second rotational locking mechanism 110b. In instances where the angular velocity and/or acceleration exceeds a threshold, the second rotational locking mechanism 110b may engage the mechanisms included in the limiting rotation section 250 thereby limiting and/or stopping rotation of the shaft 226, the belt 112, and the torque tube 106. Correspondingly, in instances where a gust of wind my cause rotation of the torque tube 106 in a clockwise direction thereby pulling out or extending the first belt 112a out of the first rotational locking mechanism 110a. Continuing the example, where the angular velocity and/or acceleration exceeds a threshold, the first rotational locking mechanism 110a may engage the mechanisms included in the limiting rotation section 250 thereby limiting and/or stopping rotation of the shaft 226, the belt 112, and the torque tube 106.

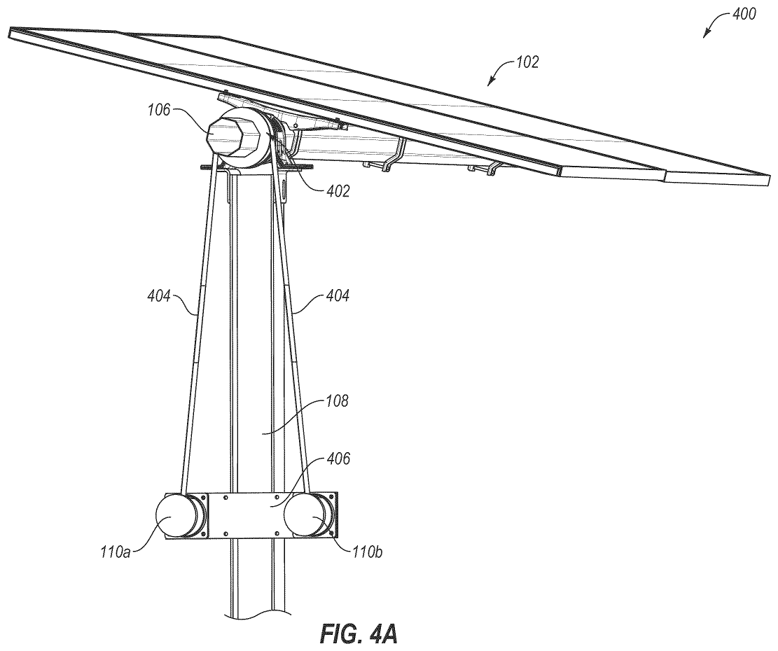

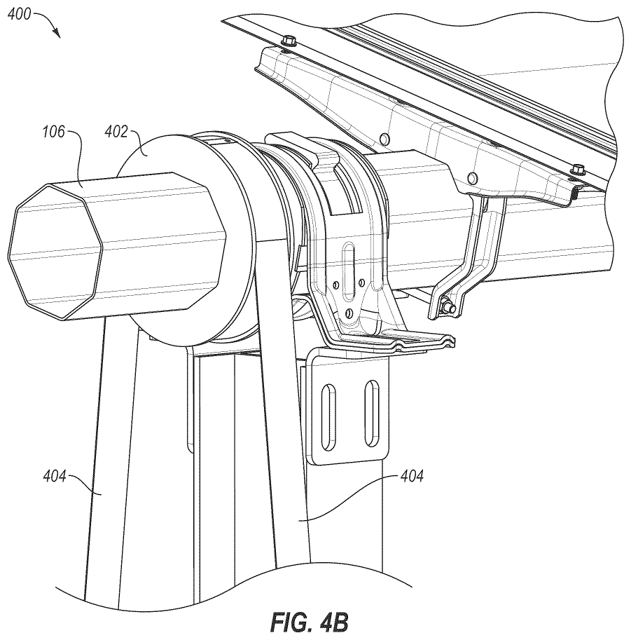

FIGS. 4A and 4B illustrate another configuration where the first and second rotational locking mechanisms 110a and 110b are used to limit or stop rotation of the torque tube 106. Like with FIGS. 3A-3C, the first rotational locking mechanism 110a may be configured to stop or limit rotation of the torque tube 106 in a clockwise direction and the second rotational locking mechanism 110b may be configured to stop or limit rotation of the torque tube 106 in a counterclockwise direction. As shown in FIGS. 4A and 4B, the belt 404 may be the same as and/or analogous to the belt 112 described and/or illustrated further in the present disclosure. As shown in FIG. 4A, the belt 404 may be one continuous belt that extends from the first rotational locking mechanism 110a to the second rotational locking mechanism 110b. In some embodiments, the belt 404 may additionally be two separate belts that may be attached or otherwise connected to the circular belt bracket 402. Additionally or alternatively, the belt 404 may include two separate belts that may be attached or otherwise connected to different locations on the circular belt bracket 402. The belt 404 extends over a circular belt bracket 402 that is designed to rotate with the torque tube 106 and rotate the belt 404 therewith. The circular belt bracket 402 enables the use of one continuous belt 404 to transmit rotation of the torque tube 106 to both the first and second rotational locking mechanisms 110a and 110b.

FIGS. 5A and 5B illustrate an example system 500 including two rotational locking mechanisms (e.g., a first rotational locking mechanism 110a and a second rotational locking mechanism 110b) and a first belt 112a and a second belt 112b designed to limit the angular velocity/acceleration of the torque tube 106. In some embodiments, the system 500 may be the same as and/or analogous to the system 100 described and/or illustrated further in the present disclosure such as, for example, with respect to FIG. 1. The first rotational locking mechanism 110a may be configured to stop or limit rotation of the torque tube 106 and/or the PV module 102 in a clockwise direction and the second rotational locking mechanism 110b may be configured to stop or limit rotation of the torque tube 106 and/or the PV module 102 in a counterclockwise direction. The first rotational locking mechanism 110a may include a first belt 112a that may be rotationally attached to a shaft (e.g., the shaft 226) within the first locking mechanism 110a and directly to the torque tube 106. The second rotational locking mechanism 110b may include a second belt 112b that may be rotationally attached to a shaft (e.g., the shaft 226) within the second locking mechanism 110 and the torque tube 106. The first and second rotational locking mechanisms 110a and 110b may be attached to either side of the support beam 108.

FIG. 6 illustrates an example system 600 including a single rotational locking mechanism 110 that is configured to stop or limit rotation of the torque tube 106 in either a clockwise or a counterclockwise direction. As shown in FIG. 6, the system 600 includes a first gear 252 that may be rotationally attached to the shaft 226 within the rotational locking mechanism 110. The first gear 252 may be described further in the present disclosure, such as, for example, with respect to FIGS. 2E and 2F. The first gear 252 may be configured to engage or interface with a second gear 602 that is rotationally attached to the torque tube 106. The first gear 602 may rotate with the torque tube 106 and that rotation may be transmitted to the first gear 252.

For example, in instances where a gust of wind or other external force my cause rotation of the torque tube 106 in a counterclockwise or a clockwise direction, the second gear 602 may rotate and the pinions corresponding to the second gear 602 engage with the pinions corresponding to the first gear 252 thereby causing rotation of the shaft 226. In instances where the angular velocity and/or acceleration exceeds a threshold, the rotational locking mechanism 110 may engage the mechanisms included in the limiting rotation section 250 thereby limiting and/or stopping rotation of the shaft 226, the first gear 252, the second gear 602, and the torque tube 106.

While the examples above described with respect to FIGS. 3A-6, describe particular rotational directions (e.g., clockwise or counterclockwise) where the locking mechanisms 110 may be configured to stop, lock, and/or limit rotation of the torque tube 106, the locking mechanisms 110 (including the first and second locking mechanisms 110a and 110b) may be configured to stop rotation of the torque tube 106 in either direction or both directions. As described in further detail in the present disclosure such as, for example, with respect to FIGS. 2G and 2H, the rotational locking mechanisms 110 may include various locking components (e.g., locking component 222 or locking components 232), internal gears 220, static cogs, pinions, gear teeth, etc. that may be configured to stop rotation of the shaft 226 and/or the torque tube 106 in any rotational direction, including both clockwise and counterclockwise directions. As such, each example described above may be adapted to stop rotation of the torque tube 106 in any rotational direction using any number of rotational locking mechanisms 110.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A rotation locking assembly for addressing dynamic effects of photovoltaic (PV) modules in a solar installation, the rotation locking assembly comprising:
a rotational locking mechanism having a shaft, a locking component rotationally connected to the shaft, and a static cog configured to engage the locking component and stop rotation of the shaft; and
a means for transmitting rotation of a torque tube to rotation of the shaft, wherein the rotational locking mechanism is configured to limit rotation of the torque tube in response to an angular velocity or angular acceleration of the torque tube exceeding a threshold.

2. The rotation locking assembly of claim 1, wherein the locking component is configured to rotate along a plurality of paths based on an angular velocity or angular acceleration of the locking component.

3. The rotation locking assembly of claim 2, wherein the angular velocity or angular acceleration of the torque tube exceeding the threshold causes the locking component to engage the static cog.

4. The rotation locking assembly of claim 2, wherein the shaft includes a proximal end and a distal end, the distal end being configured to rotationally attach to the locking component and the proximal end being configured to rotationally attach to a torsional spring.

5. The rotation locking assembly of claim 1, wherein the means for transmitting rotation of the torque tube includes a belt attached to the torque tube and coiled around the shaft, the belt being configured to transmit rotation of the torque tube to the shaft.

6. The rotation locking assembly of claim 1, wherein the means for transmitting rotation of the torque tube includes a first gear rotationally attached to the torque tube and configured to engage with a second gear rotationally attached to the shaft such that rotation of the first gear causes rotation of the second gear.

7. The rotation locking assembly of claim 3, wherein the locking component is a first locking component, further comprising:
a second locking component and a second static cog, wherein the angular velocity or the angular acceleration of the torque tube exceeding the threshold causes the second locking component to engage the second static cog.

8. The rotation locking assembly of claim 1, wherein:
the rotational locking mechanism is a first rotational locking mechanism that is configured to limit rotation of the torque tube in a first direction; and
the means for transmitting rotation of the torque tube is a first means for transmitting rotation of the torque tube in the first direction to rotation of the shaft in a first direction, further comprising:
a second rotational locking mechanism having a second shaft, a second locking component rotationally connected to the second shaft, and a second static cog configured to engage the second locking component and stop rotation of the second shaft; and
a second means for transmitting rotation of the torque tube in a second direction to movement within the second rotational locking mechanism.

9. A rotation locking assembly for addressing dynamic effects of photovoltaic (PV) modules in a solar installation, the rotation locking assembly comprising:
a rotational locking mechanism having a shaft, a locking component rotationally connected to the shaft, and a static cog configured to engage the locking component and stop rotation of the shaft; and
a belt attached to a torque tube and coiled around the shaft, the belt being configured to transmit rotation of the torque tube to the shaft, wherein the rotational locking mechanism is configured to limit rotation of the torque tube in response to an angular velocity or an angular acceleration of the torque tube exceeding a threshold.

10. The rotation locking assembly of claim 9, wherein the locking component is configured to rotate along a plurality of paths based on an angular velocity or an angular acceleration of the locking component.

11. The rotation locking assembly of claim 10, wherein the angular velocity or the angular acceleration of the torque tube exceeding the threshold causes the locking component to engage the static cog.

12. The rotation locking assembly of claim 10, wherein the shaft includes a proximal end and a distal end, the distal end being configured to rotationally attach to the locking component and the proximal end being configured to rotationally attach to a torsional spring.

13. The rotation locking assembly of claim 11, wherein the locking component is a first locking component, further comprising:
a second locking component and a second static cog, wherein the angular velocity or the angular acceleration of the torque tube exceeding the threshold causes the second locking component to engage the second static cog.

14. The rotation locking assembly of claim 9, wherein:
the rotational locking mechanism is a first rotational locking mechanism that is configured to limit rotation of the torque tube in a first direction; and
the belt is a first belt, the first belt configured to transmit rotation of the torque tube in a first direction to the shaft, further comprising:
a second rotational locking mechanism having a second shaft, a second locking component rotationally connected to the second shaft, and a second static cog located at a second distance from the second locking component; and
a second belt attached to the torque tube and coiled around the second shaft, the second belt being configured to transmit rotation of the torque tube in a second direction to the second shaft.

15. A rotation locking assembly for addressing dynamic effects of photovoltaic (PV) modules in a solar installation, the rotation locking assembly comprising:
a rotational locking mechanism having a shaft, a locking component rotationally connected to the shaft, a static cog configured to engage the locking component and stop rotation of the shaft, and a first gear rotationally attached to the shaft; and
a second gear rotationally attached to a torque tube and configured to interface with the first gear to transmit rotation of the torque tube to the shaft, wherein the rotational locking mechanism is configured to limit rotation of the torque tube in response to an angular velocity or an angular acceleration of the torque tube exceeding a threshold.

16. The rotation locking assembly of claim 15, wherein the locking component is configured to rotate along a plurality of paths based on an angular velocity or an angular acceleration of the locking component.

17. The rotation locking assembly of claim 16, wherein the angular velocity or the angular acceleration of the torque tube exceeding the threshold causes the locking component to engage the static cog.

18. The rotation locking assembly of claim 16, wherein the shaft includes a proximal end and a distal end, the distal end being configured to rotationally attach to the locking component and the proximal end being configured to rotationally attach to a torsional spring.

19. The rotation locking assembly of claim 17, wherein the locking component is a first locking component, further comprising:
a second locking component and a second static cog, wherein the angular velocity or the angular acceleration of the torque tube exceeding the threshold causes the second locking component to engage the second static cog.

20. The rotation locking assembly of claim 15, wherein the first gear has a first diameter that is different than a second diameter of the second gear.
